(19) United States
(12) Patent Application Publication
(10) Pub. No.: US 2010/0116623 A1
(43) Pub. Date: May 13, 2010

(54) TRANSMISSION DEVICE FOR THIN AND BRITTLENESS SUBSTRATE

(75) Inventors: Chen-Chung Du, Hsinchu City (TW); Kang-Feng Lee, Taipei City (TW); Muh-Wang Liang, Miaoli County (TW); Chan-Hsing Lo, Hsinchu County (TW); Tung-Chuan Wu, Hsinchu City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INDUSTRIAL TECHNOLOGY RESEARCH INSTITUTE, Hsin-chu (TW)

(21) Appl. No.: 12/420,553

(22) Filed: Apr. 8, 2009

(30) Foreign Application Priority Data
Nov. 13, 2008 (TW) 097143791

(51) Int. Cl. B65G 29/00

(52) U.S. Cl. 198/624

(57) ABSTRACT

A transmission device for thin and brittleness substrate is disclosed, which comprises: a plurality of transportation rollers and a plurality of pinch rollers. Each transportation roller further comprises: a rigid spindle; and a plurality of elastic supporting wheels, mounted on the spindle. Each pinch roller comprises: a sleeve; a spindle, ensheathed in the sleeve; and a plurality of pressing wheels, mounted on the sleeve at positions corresponding to the supporting wheels. When the transportation rollers are driven to rotate, a substrate sandwiched between the supporting wheels and the pressing wheels will be push to move while subjecting to a friction originated from a sufficient holding force by the supporting wheels and the pressing wheels, and consequently, providing an improved buffering capability for deformation absorption that enables the transmission device to guide the thin substrate to move smoothly without causing buckling or scratching to the thin substrate.

### FIELD OF THE INVENTION

The present invention relates to a transmission device for thin and brittleness substrate, and more particularly, to a transmission device structured with greatly improved deformation buffering capability, capable of guiding a thin substrate to move smoothly without causing any damage to the substrate during the transmission, while the same time exerting a sufficient holding force and friction on the substrate for pushing the same to move without causing any damage to the surface of the substrate.

### BACKGROUND OF THE INVENTION

In semiconductor or solar cell industry, substrates such as silicon sheet, silicon plate or wafer, are transported by conventional transmission devices, in which the substrate are pressed and hold by at least a pair of upper pinch roller and lower pinch roller for allowing the substrate to be move on a specific track defined in the transmission device by the fiction exerted from the rotating pinch rollers, and thus sending the substrate to move continuously passing a number of production stations in a manufacturing process, such as chemical soaking station, drying station, and so on.

Please refer to FIG. 1 to FIG. 4, which show a conventional transmission device. In the figures, the conventional transmission device 100 comprises: a plurality of transportation rollers 10 and a plurality of pinch rollers 20. In addition, each transportation roller 10 is further comprised of: a spindle 11; two radially extruding supporting wheels 12, being mounted on the spindle 11 for supporting a substrate 30; two track wheels 13, mounted on the spindle 11 at positions outside the two supporting wheels 12 for defining the substrate 30 to move in a specific track; in which the outer diameter D13 of each track wheel 13 is larger than the outer diameter D12 of its corresponding supporting wheel 12. It is noted that the substrate 30 usually is a brittle device such as a silicon wafer, etc. The plural pinch rollers 20 are arranged above the plural transportation rollers 10 and each of which is composed of: a spindle 21, arranged parallel with the spindle 11 at a specific distance d away; and a sleeve 22, having two radially extruding pressing wheels 23 mounted thereon at positions corresponding to the two supporting wheels 12 on the transportation roller's spindle 11. As the substrate 30 is sandwiched tightly between the pressing wheels 23 and the supporting wheels 12, it can be pushed to move by the fiction exerted from the rotating rollers, as shown in FIG. 4. Moreover, as the pressing wheels 23 and the supporting wheels 12 are mostly made of rigid materials, the periphery of those wheels 23, 12 are covered by buffering tires 231, 121 which are usually made of an elastic material such as rubber. In addition, there are two elongated holes 222 formed on the sleeve 22 at two radially opposite positions relative to spindle 21 and each elongated hole 222 is characterized by a specific length L. As shown in FIG. 2 and FIG. 4, the two elongated holes 222 are provided for a pin 24 to pass therethrough for allowing the two ends of the pin 24 to fit loosely therein. Thereby, the pressing wheels 23 of the sleeve 22 can press naturally on their corresponding supporting wheels 12, and the same time that the sleeve 22 is prevented from moving axially by the restriction of the pin 24 but only allows to rotate about the axis thereof as the angular range of rotation of the sleeve 22 is defined by the specific length L of the two elongated holes 222.

As shown in FIG. 3 and FIG. 4, when the spindle 11 is driven to rotate by an external power source, the supporting wheels 12 and the track wheels 13 will be brought to rotate as well. Thus, the elastic buffering tires 121 will exert a friction on the substrate 30 which is placed on the supporting wheels 12 for pushing the substrate 30 to move forward along with the rotate of the supporting wheels 12. When the substrate 30 approaches the pressing wheels 20, the pushing from the forward moving substrate 30 will lift the pressing wheels 23 and the sleeve 22 for allowing the substrate 30 to be tightly sandwiched between the pressing wheels 23 and the baring wheels 12 by the elasticity and friction of the buffering tires 121, 231. Thereby, the substrate 30 can be prevented from skewing by vibration as it is being driven to move, which is especially true for preventing the substrate from sliding and the consequent crush when the substrate 30 is moving on an inclined track for transporting the same to or away from a chemical soaking pool.

However, the aforesaid substrate transmission is short in that: despite that the periphery of those wheels 23, 12 are covered by buffering tires 231, 121, the process of transmitting the substrate 30 continuously might not be carried out smoothly as the volumes of the elastic buffering tires 231, 121 are comparatively smaller in relative to those of the rigid wheels 23, 12 so that the buffering tires 231, 121 may not be sufficiently deformed for smoothing the substrate transmission. The above description is especially true when the track of the substrate is inclined. For instance, when a substrate, being brought to move on an inclined track, encounters a pressing wheel 12 while the pushing of moving substrate is unable to raise the pressing wheel 12, the rigidity of the corresponding supporting wheel 23 with insufficiently deformed buffering tire 231 will hamper the substrate transmission in a way that the sequentially transmitted substrates may collide with one another and thus cause damage to the substrates by overly high clipping force, or by compressing and buckling resulting from the collision.

Therefore, the material selection as well as the resulting deformation design for the supporting wheels 12, the pressing wheels 23, and the buffering tires 121, 231 are becoming key issues for configuring a transmission device capable of exerting a sufficient holding force and friction on the substrate 30 for pushing the same to move without causing any damage to the surface of the substrate, and the same time capable of providing more sufficient deformation for guiding the thin substrate 30 to move smoothly without causing the sequentially transmitted substrates to collide with one another and thus causing the same to be damaged by overly high clipping force, or by compressing and buckling resulting from the collision.

### SUMMARY OF THE INVENTION

The present invention relates to a transmission device for thin and brittleness substrate that is a transmission device structured with greatly improved deformation buffering capability, capable of guiding a thin substrate to move smoothly without causing any damage to the substrate during the transmission, while the same time exerting a sufficient holding force and friction on the substrate for pushing the same to move without causing any damage to the surface of the substrate.

To achieve the above object, the present invention provides a transmission device for thin and brittleness substrate, primarily comprising a plurality of transportation rollers and a plurality of pinch rollers, in which each transportation roller further comprises: a spindle, made of a rigid material; and a plurality of supporting wheels, made of an elastic material such as rubber and being radially disposed on the spindle while protruding out therefrom; and each pinch roller comprises: a sleeve; a spindle, being ensheathed in the sleeve; and a plurality of pressing wheels, made of an elastic material such as rubber and being radially disposed on the sleeve while protruding out therefrom at positions corresponding to the supporting wheels mounted on the spindle of the transportation roller.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a conventional transmission device.

FIG. 2 is a top view of a pinch roller used in the conventional transmission device of FIG. 1.

FIG. 3 is a cross sectional view of the conventional transmission device of FIG. 1.

FIG. 4 is a side view of the conventional transmission device of FIG. 1.

FIG. 5 is a cross sectional view of a transmission device according to a first embodiment of the invention.

FIG. 6 shows stress-deformation curves for the transmission device of FIG. 5 and the conventional transmission device of FIG. 1.

FIG. 7 is a cross sectional view of a transmission device according to a second embodiment of the invention.

FIG. 8 is a cross sectional view of a transmission device according to a third embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

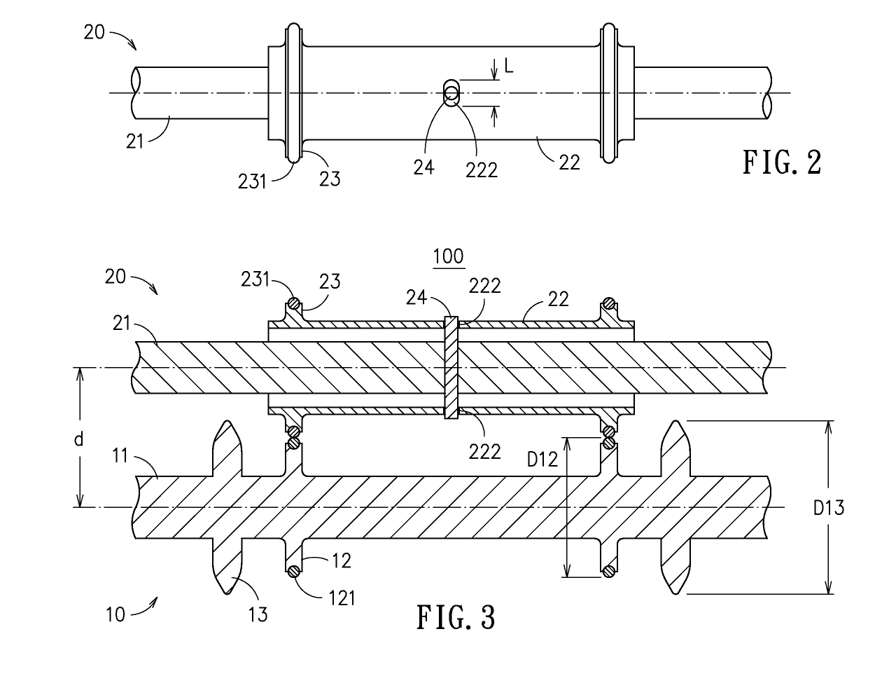

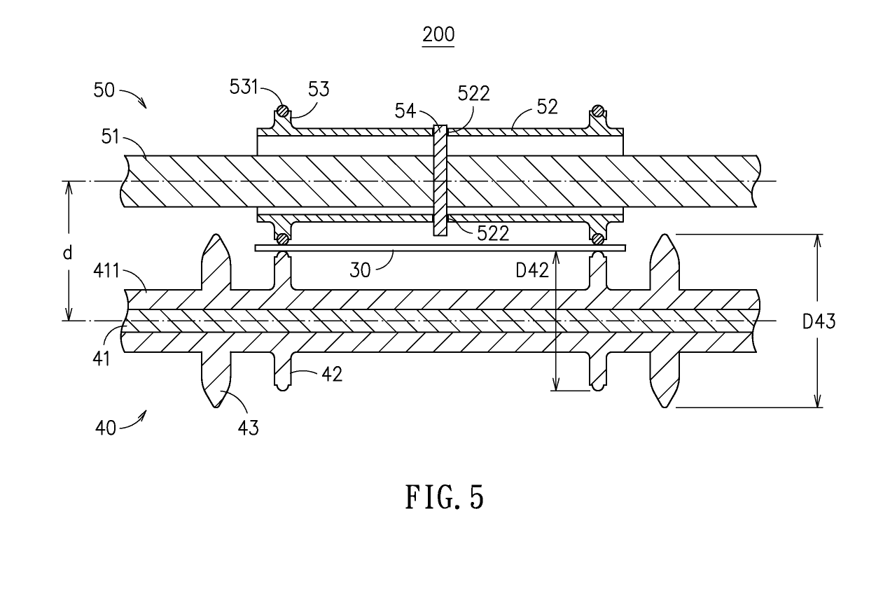

Please refer to FIG. 5, which is a cross sectional view of a transmission device according to a first embodiment of the invention. The transmission device 200 of FIG. 5 includes a plurality of transportation rollers 40 and a plurality of pinch rollers 50. Each transportation roller 40 is further comprised of: a rigid spindle 41; a rubber layer 411, being formed wrapping on the exterior of the spindle 41 for covering the same; two radially extruding supporting wheels 42, being formed on the rubber layer 411 while mounting on the spindle 11 for supporting a substrate 30; and two track wheels 43, mounted on the spindle 41 at positions outside the two supporting wheels 12 for defining the substrate 30 to move in a specific track; in which the outer diameter D43 of each track wheel 43 is larger than the outer diameter D42 of its corresponding supporting wheel 42. It is noted that the substrate 30 usually is a brittle device such as a solar wafer, etc. Moreover, the plural pinch rollers 50 are arranged above the plural transportation rollers 40 and each of which is composed of: a spindle 51, arranged parallel with the spindle 41 at a specific distance d away; and a sleeve 52, having two radially extruding pressing wheels 53 mounted thereon at positions corresponding to the two supporting wheels 42 on the transportation roller's spindle 41. In this embodiment, there is an elastic buffering tire 531 disposed on the periphery of each pressing wheel 531 as the buffering tire 531 can be made of rubber. Moreover, there are two elongated holes 522 formed on the sleeve 52 at two radially opposite positions relative to spindle 51 and each elongated hole 522 is characterized by a specific length L, similar to those shown in FIG. 2 and FIG. 4 As shown in FIG. 5, the two elongated holes 522 are provided for a pin 54 to pass therethrough for allowing the two ends of the pin 54 to fit loosely therein. Thereby, the pressing wheels 53 of the sleeve 52 can press naturally on their corresponding supporting wheels 42, and the same time that the sleeve 52 is prevented from moving axially by the restriction of the pin 54 but only allows to move up and down along the pin 54. As the substrate 30 is sandwiched tightly between the pressing wheels 53 and the supporting wheels 52, it can be pushed to move by the fiction exerted from the rotating rollers while being tightly confined in between, as shown in FIG. 5.

The transmission device of the invention is characterized in that: its supporting wheels 42 are made of a rubber, such as NBR, HNBR, FPM, Silicone, PTFE, TFM, CR or AR, etc. In this embodiment, the supporting wheels 42 are integrally formed with the rubber layer 411, and similarly the pressing wheels 53 are also integrally formed with the sleeve 52. As for the type of rubber selected for making rubber layer 411, it is dependent upon the sizes of the supporting wheels 42 and the pressing wheel 53 and also upon the material of the substrate that is being transmitted thereby and its size as well, so that there is no special restriction regarding to material of the rubber layer 411. Moreover, the supporting wheels 42 and the pressing wheel 53 can either be made of the same or different materials, but they should all be made of a material with acid and alkali resistance so that they can be adapted for the substrate transmission operation in a manufacturing process with chemical soaking or etching procedures. In this embodiment, when the supporting wheels 42 are entirely made of rubber, their deformation, that is resulted from the pushing of the substrate 30 moving up on down by an inclined angle to be sandwiched between the supporting wheels 42 and the pressing wheels 53, is about three times of that comparing with the conventional supporting wheels that are made of a rigid material. Thus, by the cooperation between the sufficient deformation of the supporting wheels 42 and the up-and-down mobility of the pressing wheels 53, the substrate 30 can be move smoothly and thus preventing the same from being damaged by overly high clipping force, or by compressing and buckling resulting from the collision in the transmission.

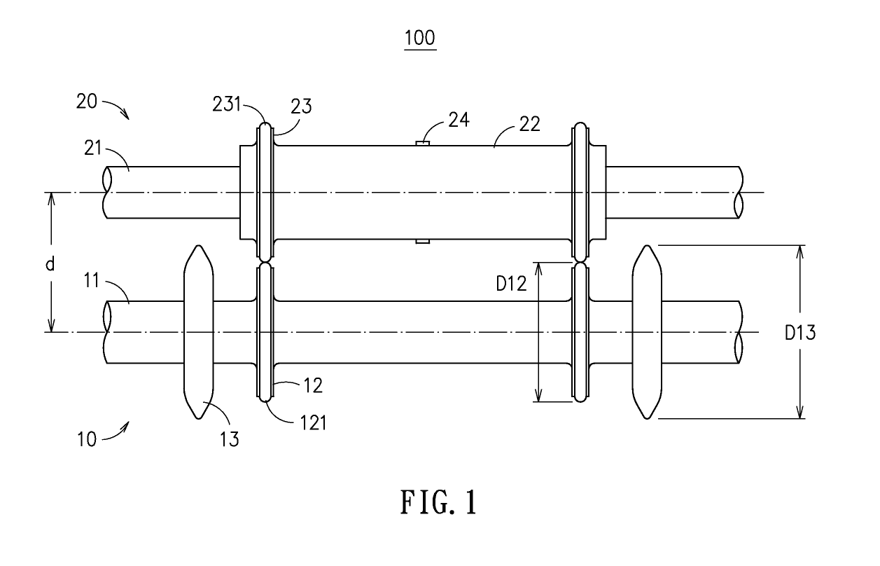

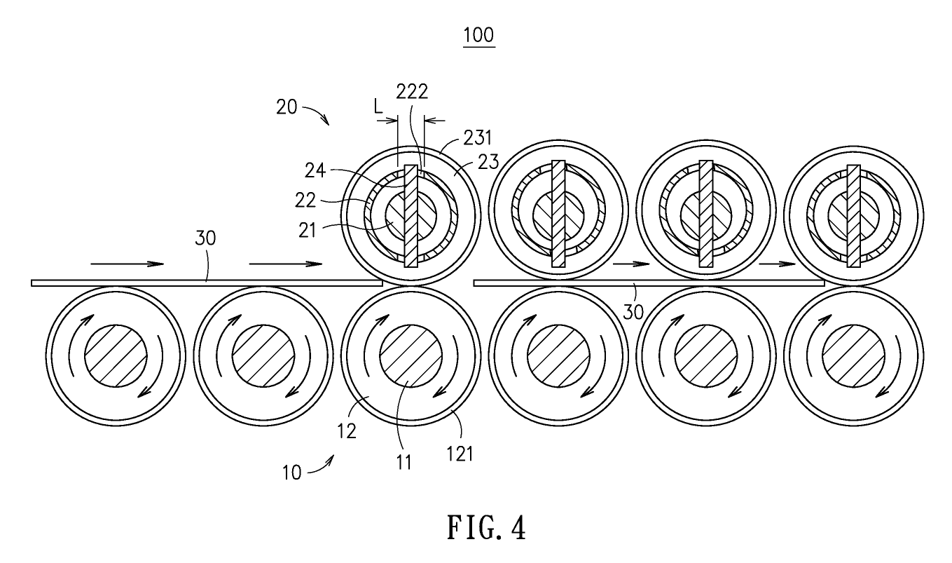

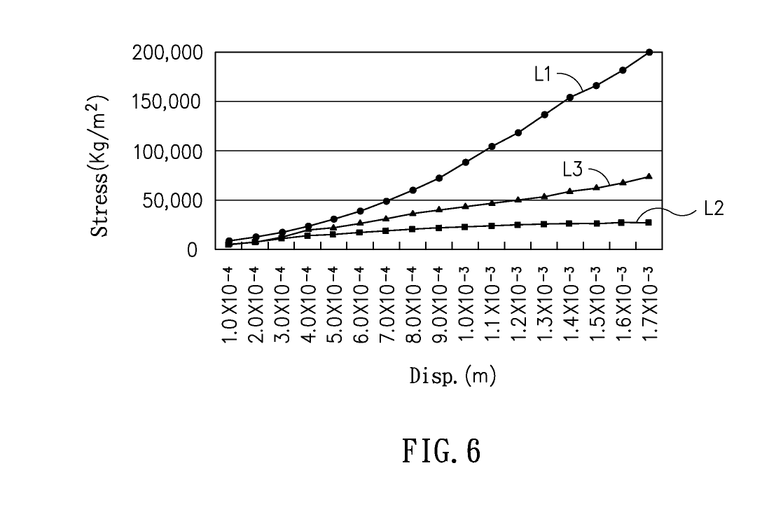

Please refer to FIG. 6, which shows stress-deformation curves for the transmission device of FIG. 5 and the conventional transmission device of FIG. 1. In the experiment described in FIG. 6, three kinds of baring wheels that are made of different materials are used for simulating how they are deformed by stress from a substrate carried thereby. In FIG. 6, the curve L1 represents the deformation of a conventional rigid supporting wheel 12 that is warped with a buffering tire 121 as the one shown in FIG. 3; and the curve L2 represents the deformation of the supporting wheel 42 shown in FIG. 5, which is made of rubber. From the curve L1 it is noted that when the deformation of the supporting wheel 12 increases from 1.0×10⁻⁴ m to 1.7×10⁻³ m, the stress for causing such deformation will increase from 6,500 kg/m³ to 200,000 kg/m³ that such stress will also act on the substrate and thus cause the same to break. On the other hand, from the curve L2 it is noted that when the deformation of the supporting wheel 42 increases from 1.0×10⁻⁴ m to 1.7×10⁻³ m, the stress for causing such deformation will increase from 3,600 kg/m³ to 25,000 kg/m³ by that the stress acting on the substrate is greatly reduced and thus the substrate is less likely t be damaged. As for the curve L3 in FIG. 6, it is resulting from a rigid supporting wheel 12 with buffering tire 121 similar to the conventional supporting wheel 12 shown in FIG. 3, but is different in that the diameter of the buffering tire 121 used in the supporting wheel of L3 is about twice that of the one used in L1. For instance, the thickness of the buffering tire resulting the curve L1 is 5 mm and the thickness of the buffering tire resulting the curve L3 is 10 mm. Thus, in curve L3, when the deformation of the supporting wheel 12 increases from 1.0×10⁻⁴ m to 1.7×10⁻³ m, the stress for causing such deformation will increase from 5,500 kg/m³ to 75,000 kg/m³, indicating that despite the increasing of thickness in buffering tire 121, the stress acting on the substrate is still larger than that acting on the substrate carried by the supporting wheels of the present invention. Accordingly, the rubber supporting wheel 42 of the invention is the best for preventing the substrate from damaging by stress. However, by the use of thicker buffering tire, the conventional rigid baring wheel can perform better than those with thinner buffering wheel.

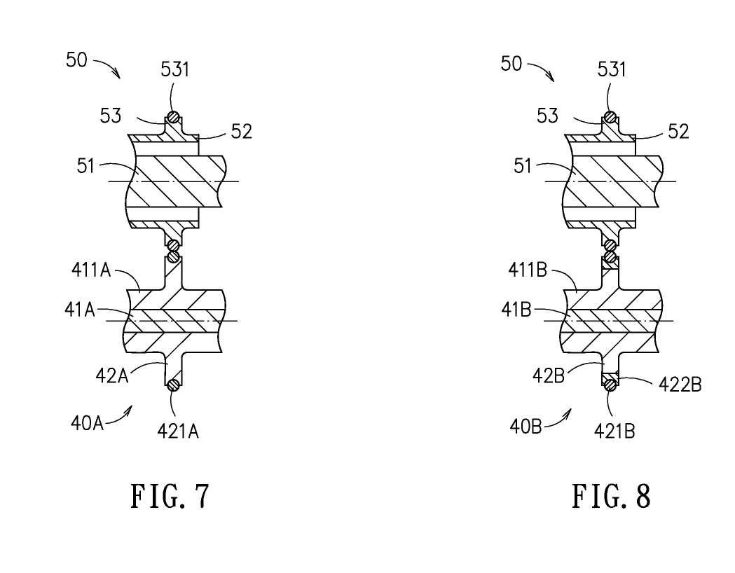

Please refer to FIG. 7, which is a cross sectional view of a transmission device according to a second embodiment of the invention. In FIG. 7, only a pair of transportation roller 40A and its corresponding pinch roller 50 are shown, in which the pinch roller 50 includes a spindle 51, a sleeve 52, a pressing wheel 53 and a buffering tire 531; and the transportation roller 40A includes: a rigid spindle 41A; a rubber layer 411A formed on the spindle 41A for covering the same; and a radially extruding rubber supporting wheel 42A, integrally formed with the rubber layer 411A. The present embodiment is characterized in that: there is further a rubber buffering tire 421A formed on the periphery of the rubber supporting wheel 42A. Accordingly, in this embodiment, all the supporting wheel 42A, the pressing wheel 53 along with their buffering tire 421A, 531 are all made of a rubber, and the rubber can be NBR, HNBR, FPM, Silicone, PTFE, TFM, CR or AR. Similarly, the supporting wheel 42A, the pressing wheel 53 along with their buffering tire 421A, 531 can either be made of the same or different materials, but they should all be made of a rubber with acid and alkali resistance so that they can be adapted for the substrate transmission operation in a manufacturing process with chemical soaking or etching procedures.

Please refer to FIG. 8, which is a cross sectional view of a transmission device according to a third embodiment of the invention. Similar to that shown in FIG. 7, the present embodiment also only shows a pair of transportation roller 40B and its corresponding pinch roller 50, in which the pinch roller 50 includes a spindle 51, a sleeve 52, a pressing wheel 53 and a buffering tire 531; and the transportation roller 40B includes: a spindle 41B, a rubber layer 411B, a supporting wheel 42B and a buffering tire 421B. The present embodiment is characterized in that: there is further a plastic buffer layer 422B sandwiched between the buffering tire 421B and the periphery of the supporting wheel 42B. For instance, the second buffer layer 422B can be made of PVC. Similarly, all the supporting wheel 42B, the pressing wheel 53 along with their buffering tire 421B, 531 are all made of a rubber, and the rubber can be NBR, HNBR, FPM, Silicone, PTFE, TFM, CR or AR. Moreover, the supporting wheel 42A, the pressing wheel 53 along with their buffering tire 421A, 531 can either be made of the same or different materials.

To sum up, the present invention relates to a transmission device for thin and brittleness substrate with greatly improved deformation buffering capability, capable of guiding a thin substrate to move smoothly without causing any damage to the substrate during the transmission, which is especially true even when the transmission track of the substrate is inclined and the pushing of moving substrate is unable to raise the pressing wheel, the deformation of the supporting wheel 42 is large enough for guiding the substrate to be correctly sandwiched between the supporting wheel and the pressing wheel 53 for preventing the substrate from being damaged by overly high clipping force, or by compressing and buckling resulting from the collision, while the same time exerting a sufficient holding force and friction on the substrate for pushing the same to move without causing any damage to the surface of the substrate.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A transmission device for thin and brittleness substrate, comprising:
a plurality of transportation rollers, each further comprising:
a spindle, made of a rigid material; and
a plurality of supporting wheels, radially disposed on the spindle while protruding out therefrom;
a plurality of pinch rollers, each further comprising:
a sleeve;
a spindle, being ensheathed in the sleeve; and
a plurality of pressing wheels, radially disposed on the sleeve while protruding out therefrom at positions corresponding to the supporting wheels mounted on the spindle of the transportation roller.

2. The transmission device of claim 1, wherein each supporting wheel is made of a rubber selected from the group consisting of: NBR, HNBR, FPM, Silicone, PTFE, TFM, CR and AR.

3. The transmission device of claim 1, wherein the rubber selected for making the supporting wheels is a material with acid and alkali resistance.

4. The transmission device of claim 1, wherein each supporting wheel is a rigid structure having a buffering tire disposed on the periphery thereof and the buffering tire is made of a rubber of more than 5mm in thickness.

5. The transmission device of claim 4, wherein the rubber for making the buffering tire is a rubber selected from the group consisting of: NBR, HNBR, FPM, Silicone, PTFE, TFM, CR and AR.

6. The transmission device of claim 1, wherein the buffering tire and the corresponding supporting wheel are made of different materials.

7. The transmission device of claim 4, wherein there is a plastic second buffer layer sandwiched between the buffering tire and the periphery of its corresponding supporting wheel.

8. The transmission device of claim 6, wherein the second buffer layer is made of PVC.

9. The transmission device of claim 6, wherein the second buffer layer, the buffering tire and the supporting wheel are made of different materials.

10. The transmission device of claim 1, wherein each pressing wheel has a buffering tire disposed on the periphery thereof and the buffering tire is made of a rubber.

11. The transmission device of claim 10, wherein the rubber for making the buffering tire is a rubber selected from the group consisting of: NBR, HNBR, FPM, Silicone, PTFE, TFM, CR and AR.

12. The transmission device of claim 1, wherein a rubber layer is formed wrapping on the exterior of the spindle of each transportation roller for covering the same in a manner that the supporting wheels corresponding to the transportation roller is integrally formed with the rubber layer.

13. The transmission device of claim 1, wherein each transportation roller further comprises:
at least a track wheel, mounted on the spindle of the transportation roller at positions outside a supporting wheel corresponding thereto while enabling the outer diameter of each track wheel to be larger than the outer diameter of its corresponding supporting wheel.

14. The transmission device of claim 1, wherein the spindles of the transportation rollers are arranged parallel to the spindles of the pinch rollers at a specific distance away.

15. The transmission device of claim 1, wherein the sleeve of each pinch roller is made of a rubber selected from the group consisting of: NBR, HNBR, FPM, Silicone, PTFE, TFM, CR and AR.

16. The transmission device of claim 15, wherein the sleeve is integrally formed with its corresponding pressing wheels.

17. The transmission device of claim 1, wherein there are two elongated holes formed on the sleeve of each pinch roller at two radially opposite positions relative to spindle.

18. The transmission device of claim 17, wherein the two elongated holes are provided for a pin to pass therethrough while allowing the pin to pass through the spindle.

19. The transmission device of claim 18, wherein the pin is fixed to the spindle while having the two ends of the pin 24 to fit loosely in the two elongated holes.

20. The transmission device of claim 1, wherein a pin is provided for penetrating and thus passing through the spindle of each pinch roller.
